(19) United States
(12) Patent Application Publication
(10) Pub. No.: US 2005/0092836 A1
(43) Pub. Date: May 5, 2005

(54) Loop coilantenna

(76) Inventor: Kazuhiro Kudo, Kyoto-shi (JP)

Correspondence Address: DICKSTEIN SHAPIRO MORIN & OSHINSKY LLP, 2101 L Street, NW, Washington, DC, 20037, US

(21) Appl. No.: 10/975,395

(22) Filed: Oct. 29, 2004

(30) Foreign Application Priority Data
Oct. 29, 2003 (JP) 2003-368192

(51) Int. Cl. G06K 7/00

(52) U.S. Cl. 235/436; 340/572.7

(57) ABSTRACT

This invention constructs an antenna matching circuit able to avoid a bad influence when a conductor, such as a metal, or tag, approaches a reader/writer, and dissolves a communication defect area on the reader/writer and stably maintains a communication distance. In this invention, in a RFID system, when the tag corresponds to the generating area of a magnetic field of the reader/writer, a radio wave for sending information to the reader/writer is outputted by operating a control circuit of the tag by electric power generated in an antenna coil of this corresponding tag. A conductor is arranged near the antenna coil of the reader/writer and an eddy current is intentionally flowed. Thus, the communication defect between the reader/writer and the tag approaching this reader/writer is reduced.

### BACKGROUND OF THE INVENTION

1. Field of the Invention

This invention relates to a RFID system (Radio Frequency Identification System) for sending and receiving information without contact by using an induced electromagnetic field between a reader/writer and a tag, and more particularly relates to a loop coil antenna able to simplify a circuit and an antenna in addition to improving communication performance.

2. Background Art

It is generally important to efficiently read authentication information recorded to the tag attached to e.g., an article, to advance automatization using collation confirmation, etc. of the article and a device. A bar code corresponding to the authentication information is recorded on the tag and is read by a bar code reader to access the information.

However, it is necessary to relate constant distance and direction with high accuracy between the bar code information and the bar code reader in order to read the bar code information using the bar code reader on which becomes an obstacle in the automatization and smoothing of the collation. Further, the amount of information able to be inputted to the bar code is small, and the managing ability of the article is limited.

Therefore, in recent years, the RFID system for sending and receiving information by wirelessly communicating between a reader/writer for generating the induced electromagnetic field and a noncontact RF tag (e.g., IC tag) used as a data carrier has been developed. In this RFID system, the distance and the direction between the reader/writer and the noncontact RF tag are not restricted so much during the reading because the induced electromagnetic field is used at the time of reading. Therefore, the authentication information recorded on the tag can be also reliably read from a separate position.

In this case, as shown in FIG. 8, the reader/writer has a loop coil antenna 83 constructed by an antenna matching circuit 81 and an antenna coil 82. When a conductor, such as a metal, or the tag approaches the loop coil antenna 83, the change of a coupling degree with the antenna coil 82 is increased. In this case, mismatching occurs in the antenna matching circuit 81. Therefore, a communication disability area is created and the communication distance is reduced.

Further, for example, in the antenna matching circuit of the present RFID system, balance-unbalance conversion is performed in a compensating coil system used in the inspecting standard of ISO10373 as shown in FIG. 9A and the antenna matching circuit using a transformer, etc. as shown in FIG. 9B to restrain a leak electric current from the antenna.

However, a problem with the adjusted circuit and antenna is that they become complex.

For example, when the signal receiving circuit is constructed, a primary band-pass filter 101, a primary wave detector 102, a secondary band-pass filter 103, a secondary wave detector 104 and a low pass filter 105 are arranged in this order as shown in FIG. 10. When the signal is modulated to a frequency of a subcarrier wave and the signal is transmitted, the information is demodulated by passing the information in this order. However, many components are required to demodulate the information by amplifying the frequency of the subcarrier wave so that the circuit becomes complex, thereby increasing the cost.

In addition to this, an antenna device of the RFID system able to dissolve the defects of communication disability, etc. caused by approaching of the conductor, (e.g., a metal), by adding a resonant frequency variable function to the antenna device is known (e.g., see JP-A-2001-344574).

However, when a tag or conductor approach the coupling device of the reader/writer and a distance change is large, a corresponding change of the coupling degree is strong, causing a communication defect area is created which may cause a near point miss or an intermediate miss within the communication area.

### SUMMARY OF THE INVENTION

An object of this invention is to provide a loop coil antenna able to dissolve the communication defect area and stably maintain the communication distance by constructing the antenna matching circuit in a manner which avoids the influence of the conductor and stabilizes this antenna matching circuit even when a conductor, such as a metal or a tag, approaches the reader/writer.

This invention is characterized in a loop coil antenna used in a RFID system. When a tag corresponds to the generating area of a magnetic field generated in an antenna coil of a reader/writer, a radio wave for sending information to the reader/writer is outputted by operating a control circuit of the tag by electric power generated in an antenna coil of this corresponding tag, wherein a conductor, insulated from the antenna coil of the reader/writer, is arranged in the interior surrounded by the antenna coil of the reader/writer.

The above conductor may be constructed with a material having magnetism. The conductor is constructed by mixing a ferromagnetic body of electrically conductive metallic plate and metallic foil, or a rubber material and magnetic powder arranged along the antenna coil of the reader/writer.

When the relation of the above conductor and the tag is considered and when the tag or the conductor, e.g., a metal, approaches the antenna coil of the reader/writer from the exterior and a separate conductor is arranged near the antenna coil of the above reader/writer, an eddy current is generated around the separate conductor. Mismatching is generated in the antenna matching circuit by the influence of the eddy current. Therefore, it is desired to design a structure that avoids having a conductor near the antenna coil of the reader/writer to avoid mismatching.

Here, if the conductor is insulated from the antenna and surrounded by the antenna coil to intentionally flow the eddy current, it is possible to restrain the influence degree, at the time of the coupling change of the antennas, when the distance between the reader/writer and the tag is reduced.

The amount of inductance is reduced by restraining the influence degree due to the coupling change of the antennas, and thereby reducing the changing amount of the antenna matching circuit in proportion to the changing amount of inductance, so that the mismatching is reduced. Due to this change, even when the coupling degree of the antennas, caused by the distance change of the reader/writer and the tag, is strong, the generation of communication disability areas of near point miss and intermediate miss of the communication area and the reduction of the communication distance are prevented, thereby securing stable communication.

Further, when the conductor is arranged in the interior surrounded by the antenna coil, the conductor can efficiently generate the eddy current between the conductor and the antenna coil of a loop shape in its outer circumference. Therefore, this is a preferable design for the restraint of the coupling change of the antennas.

In this case, the reader/writer is constructed separately from the driving circuit. Further, the reader/writer of an integral type can be constructed where the driving circuit and reader/writer are integrated. Thus, the various designs of the reader/writer circuit can be used in accordance with the embodiments of this invention.

In accordance with this invention, when the tag or conductor, such as an electrically conductive metal, approaches the reader/writer, the change of the coupling degree, caused by the distance change, can be reduced. Therefore, an appropriate communication area can be secured and the communication distance is maintained and the generation of the communication disability area is prevented.

An inappropriate influence due to the change of the distance between the reader/writer and the tag is restrained by arranging the conductor near the antenna coil of the reader/writer and intentionally flowing the eddy current to this conductor.

### BRIEF DESCRIPTION OF THE DRAWINGS

FIG. 1 is a perspective view showing a using state of a separating type reader/writer;

FIG. 2 is a perspective view showing one example of the reader/writer of an integral type;

FIG. 3 is a view showing the arranging state of a metallic plate of the separating type reader/writer;

FIG. 4 is an electric circuit diagram showing an antenna matching circuit of the separating type reader/writer;

FIG. 5 is an electric circuit diagram showing a signal transmitting circuit of the separating type reader/writer;

FIG. 6 is a time chart showing the waveform of each signal of the signal transmitting circuit;

FIG. 7 is a block diagram showing the construction of a signal receiving circuit;

FIG. 8 is a view showing a conventional antenna matching circuit having no metallic plate and also showing an antenna coil;

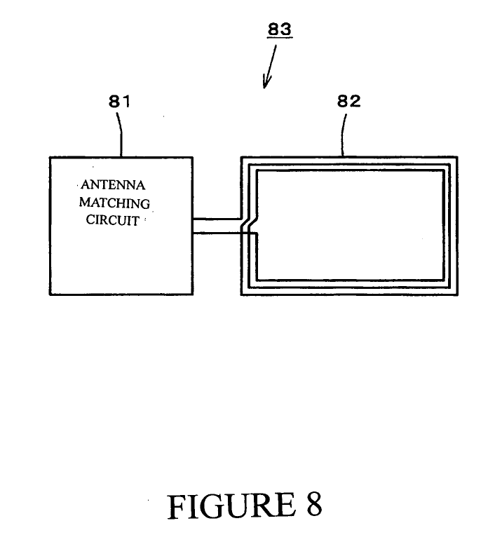

FIG. 9 is an electrical circuit diagram showing each conventional antenna matching circuit; and

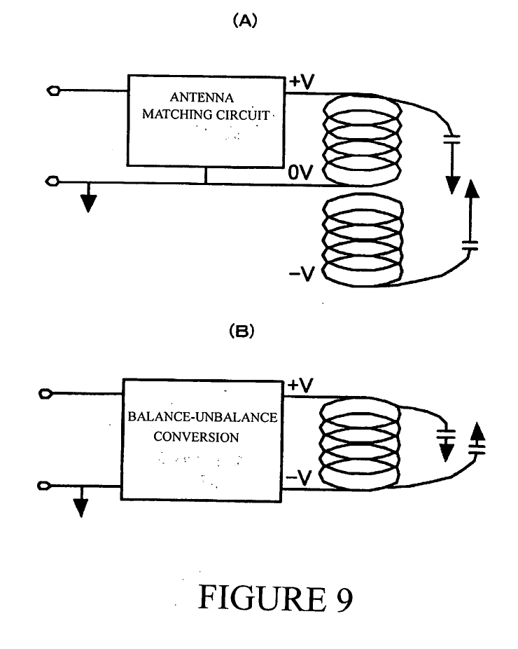

FIG. 10 is a block diagram showing the construction of a conventional signal receiving circuit.

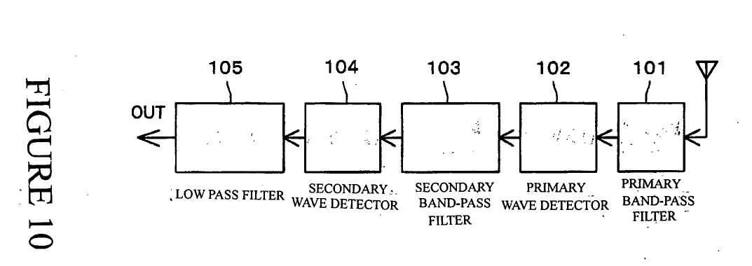

### DESCRIPTION OF THE PREFERRED EMBODIMENTS

The embodiments of this invention will next be explained in conjunction with the drawings.

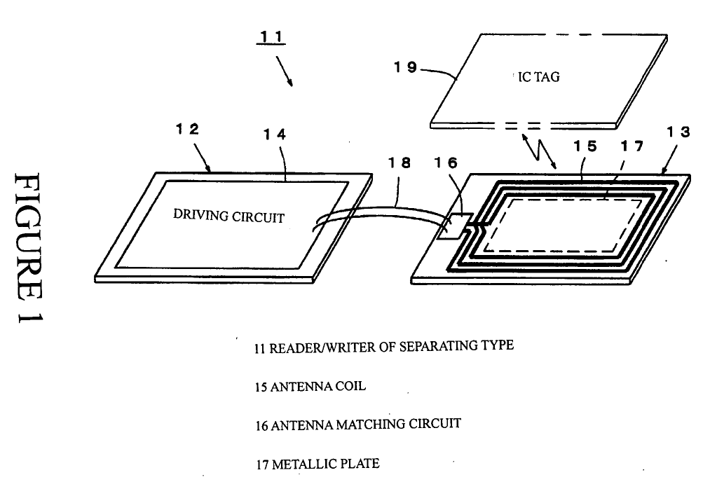

FIG. 1 shows a reader/writer of a separating type used in the RFID system. In FIG. 1, this reader/writer 11 of the separating type is arranged by separating a reader/writer substrate 12 and an antenna substrate 13, both made using a resin material being non-electrically-conductive.

A driving circuit 14 for reading and writing information is mounted to the reader/writer substrate 12. An antenna coil 15 constructed as a loop coil antenna, an antenna matching circuit 16 and an electrically conductive metallic plate 17 are mounted and arranged in the antenna substrate 13. Wiring 18 is connected between the reader/writer substrate 12 and the antenna substrate 13.

When a magnetic field is generated in the antenna coil 15 from the above reader/writer 11 and an approaching IC tag 19 enters this magnetic field generating area, an unillustrated control circuit of the IC tag 19 is operated by the electric power generated in an antenna coil of the IC tag 19, where information is sent and received by communicating with the above reader-writer 11.

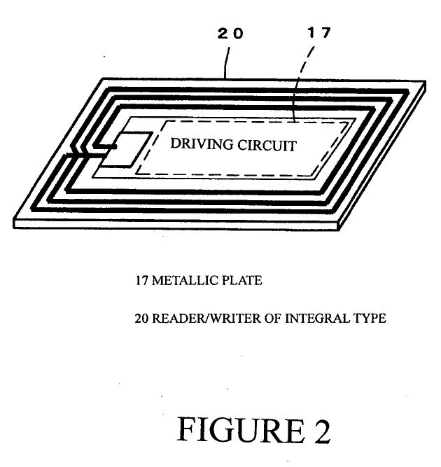

The above reader/writer substrate 12 and the antenna substrate 13 which are separated from each other, may also be vertically overlapped and integrally arranged, in addition to the separating arrangement as shown in FIG. 2. Further, a mounting part may be also assembled and arranged in one of the substrates and can also be arranged in the reader/writer 20 of an integral type, integrated as a simplex as shown in e.g., FIG. 2.

The above metallic plate 17 may be a conductor able to generate an eddy current. For example, the metallic plate 17 is mounted to the central portion of the antenna surrounded by the antenna coil 15 of a loop shape along the rectangular shape of the substreate 13, having the rectangular shape, or is buried and integrally attached to the central portion.

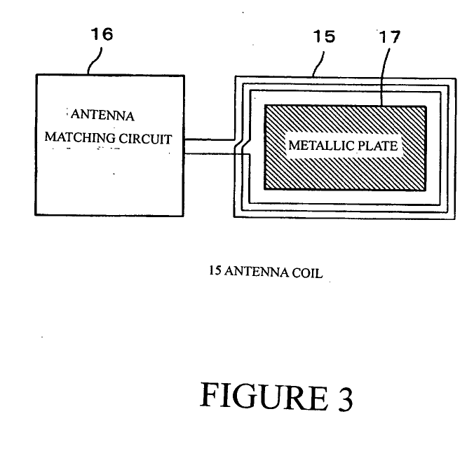

FIG. 3 shows the arrangment of the above metallic plate 17 and the antenna coil 15. The metallic plate 17 of the same rectangular shape is arranged in the position of the interior surrounded by the antenna coil 15, which is arranged in the loop shape of the substrate. When the metallic plate 17 is arranged in this way, the metallic plate 17 can efficiently generate the eddy current on the external surface of the metallic plate 17 by receiving the influence of a magnetic field generated from the antenna coil 15.

In this case, an influence degree, due to a coupling change of the antennas, of the distance between the reader/writer 11 and the tag 19 can be restrained by positively arranging the metallic plate 17 and intentionally flowing the eddy current to the metallic plate 17. The amount of the inductance of the antenna coil 15 is reduced by this restraining action, and the changing amount of the antenna matching circuit is also reduced in proportion to the change in the inductance component, thereby reducing mismatching. As a result, even when the coupling degree of the antennas, caused by the distance change of the reader/writer and the tag, is strong, it is possible to prevent the generation of communication disability areas, which may case a near point miss and an intermediate miss within the communication area and a reduction in communication distance.

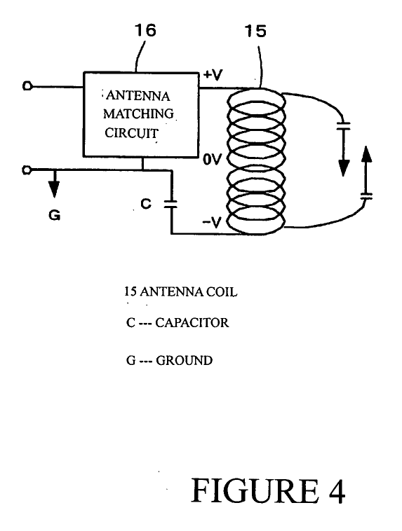

FIG. 4 shows a circuit diagram of the antenna matching circuit 16 and the antenna coil 15 arranged in the antenna substrate 13 of the reader/writer 11. This circuit is constructed by interposing a capacitor C for balance-unbalance conversion between the antenna coil 15 and the ground G.

In this case, the balance-unbalance conversion of the antenna coil 15 on the reader/writer 11 side can be performed and a leak electric current from the antenna coil 15 is restrained by interposing only one capacitor C between the antenna coil 15 and the ground G. Therefore, the balance-unbalance conversion can be realized without requiring a complicated circuit and a coil. Accordingly, if such a circuit is constructed, common mode noises, unnecessary radiation, and the amount of leaked electric current can be reduced, although it is a simple circuit.

In particular, since the original coil can be used at twice an inductance value of about and the antenna coil electric current can be reduced to half without changing the original coil, etc., the restriction can be reduced when the reader/writer 11 is compactly manufactured.

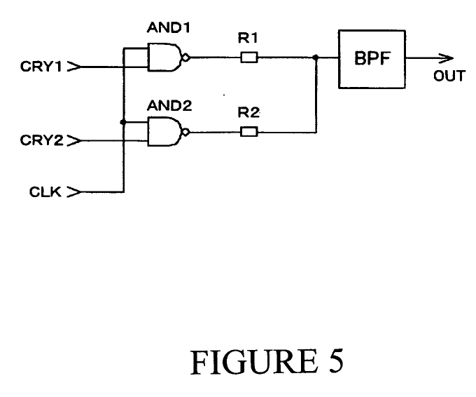

FIG. 5 shows a signal transmitting circuit of the reader/writer 11. This signal transmitting circuit is constructed as shown in FIG. 5 by sequentially connecting logic product circuits AND1, AND2 connected to the terminals of inputted control signals CRY1, CRY2 and clock signal CLK, resistors R1, R2 and a band-pass filter BPF. When the control signals CRY1, CRY2 are inputted, rectangular waves of these control signals CRY1, CRY2 are read out by taking input timing by the clock signal CLK and the logic product circuits AND1, AND2. These read rectangular waves are divided in resistance by the resistors R1, R2 and then passed through the band-pass filter (BPF).

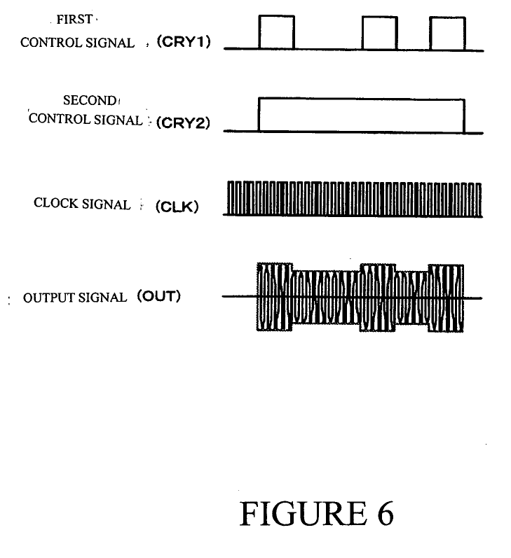

Thus, as shown by the time chart of FIG. 6, a stable amplitude modulating signal (ASK signal) which is influenced by a delay, etc. is generated. Since such a stable amplitude modulating signal can be generated, the stable modulating signal can be output from the signal transmitting circuit. Further, if such a signal transmitting circuit is used, the circuit can be simply constructed so that the circuit can be manufactured at low cost.

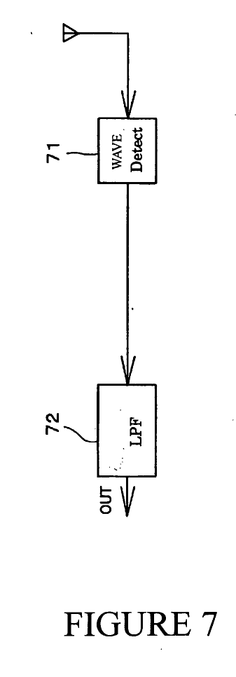

FIG. 7 shows a signal receiving circuit of the reader/writer 11. This signal receiving circuit is constructed as shown in FIG. 7 by sequentially connecting a wave detector 71 and a low pass filter 72. When information is modulated to a frequency of a subcarrier wave and is transmitted by the signal receiving circuit, the information is modulated by passing it through the wave detector 71 and the low pass filter 72.

In this case, since the information can be modulated to the frequency of the subcarrier wave by the wave detector 71, and the low pass filter 72 and can be received, it is possible to construct a simple signal receiving circuit in which a plurality of band-pass filters and secondary wave detectors are omitted. Accordingly, the number of parts is reduced and the signal receiving circuit is simplified and can be manufactured at a low cost. If such a signal receiving circuit is used, the distance between the reader/writer 11 and the tag 19 is also reduced. Accordingly, even in a high coupling state of the antennas, the information can be easily demodulated without amplifying the frequency of the subcarrier wave.

A using state of the reader/writer 11 of the separating type constructed in this way will next be explained. When the IC tag 19 approaches the antenna substrate 13 of the reader/writer 11 of the separating type, and enters a communication area formed in the antenna substrate 13, the IC tag 19 outputs a radio wave for sending information to the reader/writer 11, by operating the control circuit of the IC tag 19 by electric power generated in the antenna coil of the IC tag 19. Information is sent and received between this IC tag 19 and the reader/writer 11.

In this case, when the distance between the reader/writer 11 and the IC tag 19 is reduced, an eddy current is generated in the metallic plate 17 mounted on the reader/writer 11. Therefore, the amount of inductance is reduced by the metallic plate 17 in the antenna coil 15 of the reader/writer 11. The changing amount of the antenna matching circuit 16 is also reduced in proportion to this changing amount of inductance. Therefore, the influence degree from the coupling change of both the antennal coils of the reader/writer 11 and the IC tag 19 is restrained. Accordingly, it is possible to secure stable matching and maintain communication performance of high reliability with the IC tag 19.

As mentioned above, it is possible to secure the communication performance with a high reliability by simply arranging the metallic plate within the antenna coil of the reader/writer. This is one means for decreasing the mismatching of the antennas due to the change in the distance between the reader/writer and the IC tag.

This invention is not limited to the detailed embodiments described above. The description of the separated reader/writer has been used as an example, but similar results can be achieved with an integrated reader/writer.

1. A loop coil antenna used in a RFID reader/writer circuit, said antenna comprising:
an antenna coil, of a reader/writer circuit, arranged in a loop for receiving electrical signals from a driving circuit and for generating an electromagnetic field for communicating with an RFID tag; and
a conductor insulated from said antenna coil arranged within an interior of said loop.

2. The loop coil antenna according to claim 1, wherein said driving circuit is integrally related to said reader/writer circuit.

3. The loop coil antenna according to claim 1, wherein said driving circuit is separated from said reader/writer circuit.

4. The loop coil antenna according to claim 1, wherein said conductor is constructed by a metallic plate buried in the interior surrounded by the antenna coil of the reader/writer.

5. A method of operating an RFID tag system, the system comprising
a reader/writer circuit and an associated tag, the method comprising the acts of:
generating an electromagnetic field by the reader/writer circuit, wherein the reader/writer comprises a conductor insulated from and surrounded by an antenna coil, provided in a substrate; and
operating a circuit of an RFID tag to output a radio wave from the tag when it recieves said electromagnetic field.

6. The method according to claim 6, further comprising the act of communication information between the tag and the reader/writer.

7. A method of making an RFID system with reduced interference comprising:
forming a reader/writer loop coil antenna in a substrate for generating an electromagnetic field, wherein the reader/writer comprises a conductor insulated from and surround by said substrate; and
providing an associated tag for producing a radio wave when introduced to said electromagnetic field.

8. The method according to claim 7, further comprising providing a driving circuit for said reader/writer.

9. The method according to claim 8, further comprising connecting said driving circuit to said reader/writer by wires.

10. The method according to claim 8, further comprising integrating said driving circuit with said reader/writer circuit.

11. A loop control antenna comprising:
a reader/writer substrate separated from an antenna substrate, wherein both of said substrates are made of a non-electrically conductive resin material;
a driving circuit, mounted on said substrate, for reading and writing information;
an antenna coil constructed as a loop antenna mounted on said antenna substrate;
an antenna matching circuit mounted on said antenna substrate;
an electrically conductive metallic plate mounted on said antenna substrate for acting as a conductor; and
wiring connecting said reader/writer circuit and said driving circuit.

12. The loop antenna according to claim 11, wherein said conductive plate is insulated and surrounded by the antenna coil.

13. A reader/writer of a loop control antenna including:
a reader/writer substrate;
a metallic plate conductor, mounted in the interior of said substrate, for generating an eddy current;
a antenna coil surrounding and insulated from said metallic plate; and
an antenna matching circuit connected to said antenna coil.

14. A reader/writing of a loop control antenna including:
a reader/writer substrate;
a driving circuit, mounted on said substrate, for reading and writing information;
an antenna substrate;
an antenna coil constructed as a loop antenna mounted on said antenna substrate;
an antenna matching circuit mounted on said antenna substrate; and
an electrically conductive metallic plate mounted on said antenna substrate, wherein said antenna substrate and said coil and matching circuit mounted thereon are integrally connected with said reader/writer substrate and said driving circuit mounted thereon.
